(19) United States
(12) Patent Application Publication
(10) Pub. No.: US 2010/0011598 A1
(43) Pub. Date: Jan. 21, 2010

(54) Hand-held power tool for driving a disc-shaped working tool

(75) Inventors: Ralf Meixner, Germaringen (DE); Guenther Veik, Maeder (AT); Hans-Joerg Rieger, Thueringen (AT)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/460,234

(22) Filed: Jul. 14, 2009

(30) Foreign Application Priority Data
Jul. 17, 2008 (DE) 10 2008 040 514.0

(51) Int. Cl. B25F 5/02; B23D 45/16; B23D 47/12

(52) U.S. Cl. 30/390; 30/276; 30/277.4

(57) ABSTRACT

A hand-held power tool for driving a disc-shaped working tool (13) includes a belt drive (15) for driving the working tool (13), a belt cover (21; 41) for at least partially covering the belt drive (15) and having, at a belt cover free end (23; 43) remote from an outer housing (14) of the power tool, a circumferential wall section (24; 44), and a separate cover element (31; 51) for the free end (23; 43) of the belt cover (21; 41) and integrated in the circumferential wall section (24, 44) at the belt cover free end (23; 43).

### BACKGROUND OF THE INVENTION

1. Field of the Invention

The present invention relates to a hand-held power tool such as an abrasive wheel cutting-off tool having a combustion engine for driving a disc-shaped working tool such as an abrasive wheel and including a belt drive for driving the working tool, a belt cover for at least partially covering the belt drive and having, at a belt cover free end remote from an outer housing of the power tool, a circumferential wall section and a cover for the circumferential wall section.

2. Description of the Prior Art

For cutting constructional components such as, e.g., concrete walls or ceilings, or for forming recesses therein, hand-held power tools with, e.g., cutting-off wheels provided with cutting segments are used. A rotatable cutting-off wheel penetrates in a constructional component and forms a cut therein. When a maximum penetration depth is reached, the free end of the belt cover engages the surface of the constructional component, whereby the free end of the belt cover is subjected to wear. Usually, the belt covers are formed of a low-cost material such as plastic material or as a light metal casting, both of which have a small wear resistance.

German company Stihl AG offers for sale under a trade designation “TS 70,” a hand-held power tool of the type discussed above in which between a belt deflection roller and a sheet cover that partially surrounds the disc-shaped working tool, there is provided an intermediate element that functions as a cover and that partially projects beyond the free end of the belt cover.

The drawback of the power tool described immediately above consists in that the belt cover, as a result of a one-sided arrangement of the circumferential wall section of the belt cover, protects the circumferential wall section only to a limited extent. Moreover, mounting of cover involves additional mounting costs.

Accordingly, an object of the present invention is a hand-held power tool for driving a disc-shaped working tool in which the free end of the belt cover is optimally protected against wear.

### SUMMARY OF THE INVENTION

This and other objects of the present invention, which will become apparent hereinafter, are achieved by providing a separate cover element for the free end of the belt cover and integrated in the circumferential wall section at the belt cover free end.

The cover element is arranged directly at the free end of the belt cover and dependent on possible use of the hand-held power tool, can be provided on the free end of the belt cover. A separate mounting of the cover element between two functional parts of the hand-held power tool is not any more necessary. The belt cover can be formed of an inexpensive material that is completely suitable for the functioning of a belt cover but that has a small wear resistance. The integrated cover element takes over the protection of the free end of the belt cover and is advantageously formed of a material having a higher wear resistance than the material the belt cover is formed of.

Advantageously, the cover element extends over a rim region adjacent to the circumferential wall section, whereby the belt cover is protected from wear at its free end and sidewise of this region. In other words, with this embodiment, the free front edge of the belt cover is advantageously protected from wear.

Advantageously, the circumferential wall section extends over an angle of 180°, and the cover element extends over from 25% to 100% of an extent of the circumferential wall section.

The extent of the cover element optimally protects from wear a sufficiently large surface of the circumferential wall section. It is particularly advantageous when the cover element extends over more than 50% of the extent of the circumferential wall section or even above 90%. In this case, the cover element extends particularly advantageously starting from the beginning of the circumferential wall section, on the lower side of the side wall of the belt cover along the circumferential wall section.

Advantageously, the cover element has at least one rib projecting radially beyond the circumferential wall section. The provision of at least one rib permits to use less material for forming a cover element, while a flat contact of the free end of the belt cover with a constructional component or workpiece is prevented, and adequate protection of the free-end of the belt cover is insured.

Advantageously, the at least one rib extends in a circumferential direction of the circumferential wall section. Thereby, with a conventional use of the hand-held power tool, the at least one rib always first contacts the surface of a constructional component upon penetration of the working tool into the constructional component.

Advantageously, the cover element has at least two, spaced from each other ribs. Thereby, even at a light inclination of the power tool in a plane perpendicular to the surface of the constructional component, an optimal protection of the free end of the belt cover against wear is insured.

Advantageously, the cover element is formed of a metal, which insures an adequate protection of the free end of the belt cover. More advantageously, the cover element is formed of sheet metal, e.g., a steel sheet, in a stamping-bending process. In a particularly advantageous embodiment, the cover element is formed of a corrosion-resistant sheet, e.g., galvanized sheet, in a stamping bending process. Alternatively, the cover element can be formed of another material that has a greater wear resistance than the material of the belt cover.

Advantageously, the belt cover is formed of a plastic material by an injection-molding process, and the cover element is partially molded into the circumferential wall section. This process insures an easy manufacturing of the belt cover and a simple integration of the cover element in the belt cover.

Alternatively, in the belt cover and, in particular, in the region of the circumferential wall section, there are provided receptacle means for receiving the cover element. This provides for a subsequent and particularly advantageous replacement of the cover element.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments when read with reference to the accompanying drawings.

### BRIEF DESCRIPTION OF THE DRAWINGS

The drawings show:

FIG. 1 a side view of a first embodiment of a hand-held power tool according to the present invention with a partially cut-off view of a belt cover;

FIG. 2 a cross-sectional view of the free end of the belt cover along line II-II in FIG. 1 at an increased, in comparison with FIG. 1, scale;

FIG. 3 a side view of a second embodiment of a hand-held power tool according to the present invention with a partially cut-off view of a belt cover; and

FIG. 4 a cross-sectional view of the free end of the belt cover along line IV-IV in FIG. 3 at an increased, in comparison with FIG. 3, scale.

Basically, in the drawings, the same parts are provided with the same reference numerals.

### DETAILED DESCRIPTION OF THE PREFERRED EMBODIMENTS

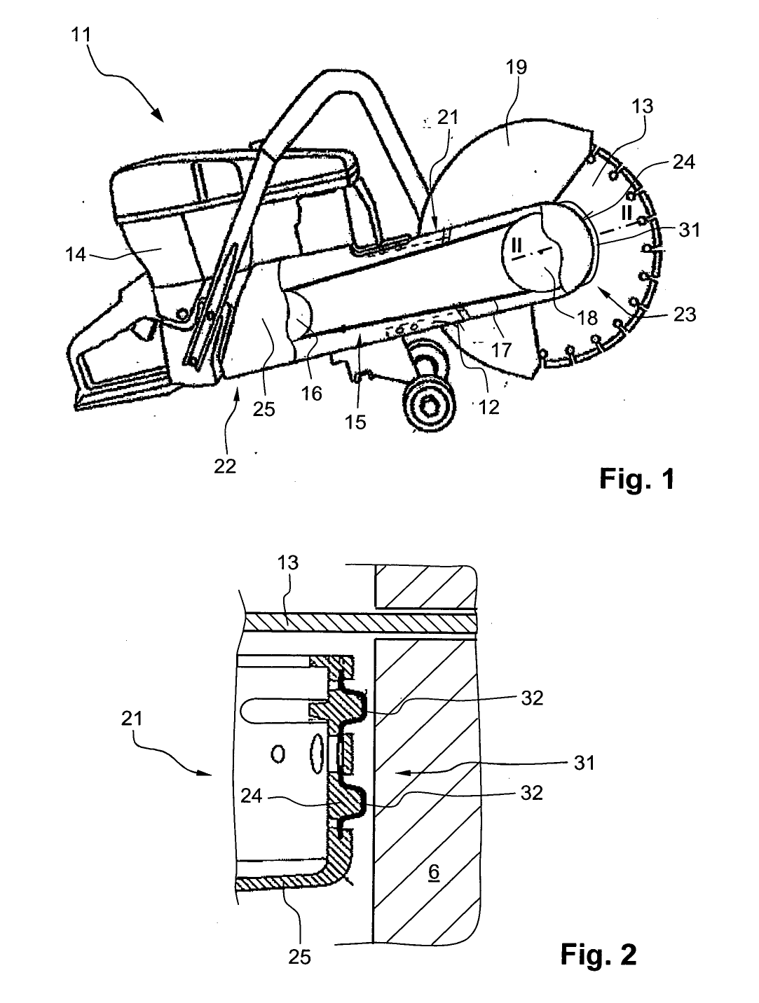

A hand-held power tool 11, which is formed as an abrasive wheel cutting-off tool driven by a combustion engine and which is shown in FIG. 1, has a cantilever arm 12 on which an abrasive wheel formed as a disc-shaped working tool 13 is mounted. A combustion engine (not shown), which is located in an outer housing 14 of the cutting-off tool 11, drives the disc-shaped working tool 13 via a belt drive 15. The belt drive 15 has a driving wheel 16 that is driven by the combustion motor directly or indirectly, a driving belt 17, and a driven wheel 18 that is arranged on a free end of the cantilever arm 12 and directly drives the disc-shaped working tool 13 which is partially surrounded by a sheet cover 19.

The belt drive 15 is covered by a belt cover 21 which is shown with a partial cut-off in order to clarify the structure of the belt drive 15. The belt cover 21 has a circumferential wall section 24 that extends over an angle of 180° at both of its ends, an end 22 adjacent to the outer housing 14 of the cutting-off tool 11 and a free end 23 remote from the outer housing 14. A side wall 25 of the belt cover 21, which is spaced from the belt drive 15 and the outer housing 14, completely covers the belt drive 15. The region of the belt cover 21 opposite the side wall 25 is formed substantially open.

A cover for the free end 23 of the belt cover 21 is formed as a separate cover element 31 integrated in the circumferential wall section 24 at the free end 23 of the belt cover 21 (as shown in FIG. 2). When the working tool 13 penetrates into the workpiece or constructional component 6, the cover element 31 engages the workpiece 6 and prevents a strong wear of the circumferential wall section 24 at the free end 23 of the belt cover 21 which can result from a direct contact of the circumferential wall section 24 with the component 6.

The cover 31 extends over from about 25% to 100%, preferably, over from about 30% to 75% of the extent of the circumferential wall section 24. The cover element 31 has two, spaced from each other ribs 32 which project radially beyond the circumferential wall section 24 and extend in the circumferential direction of the circumferential wall section 24.

The cover element 31 is formed of metal, preferably sheet metal by a stamping-bending process. The belt cover 21 is formed of a plastic material by an injection-molding process, with the cover element 31 being partially molded in the circumferential wall section 24.

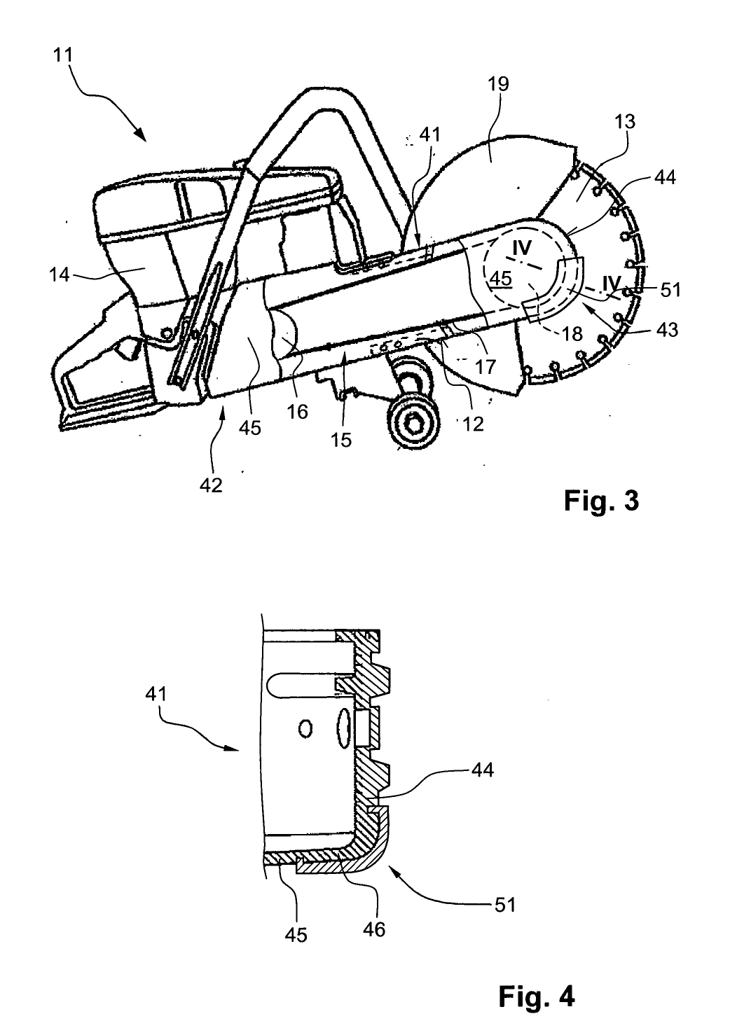

The hand-held power tool 11, which is shown in FIG. 3, corresponds to the power tool 11 shown in FIG. 1, except the belt cover 41. Therefore, the parts of the power tool 11 shown in FIG. 3 similar to those of the power tool 11 shown in FIG. 1, are designated with the same reference numerals.

The belt cover 41 has at its free end a circumferential wall section 44 that extends over an angle of 180°. The side wall 45 of the belt cover 41, which is spaced from the belt drive 15 and the outer housing 14, completely covers the belt drive 15 and has a rim region 46 extending toward the circumferential wall section 44.

As a cover for the free end 43 of the belt cover 41, there is provided a separate cover element 51 that is integrated on one hand, in the circumferential wall section 44 and, on the other hand, in the side wall 45 (as shown in FIG. 4). The cover element 51 extends over a rim region 46 adjacent to the circumferential wall section 44.

The cover element 51 extends over 50% of the extent of the circumferential wall section 44 and over a section of the side wall 45, which adjoins the circumferential wall section 44, in a direction of the end 42 of the belt cover 41 adjacent to the outer housing 14 of the power tool 11. The cover element 51 projects beyond the circumferential wall section 44 and beyond the side wall 45 in such a way that the outer side of the belt cover 41 remote from the belt drive 15 is protected from a contact with the surface of the to-be-treated components or workpieces.

The cover element 51 is preferably formed of a material that is harder than the material of which the belt cover 41 is formed.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A hand-held power tool for driving a disc-shaped working tool (13), comprising a belt drive (15) for driving the working tool (13); a belt cover (21; 41) for at least partially covering the belt drive (15) and having, at a belt cover free end (23; 43) remote from an outer housing (14) of the power tool, a circumferential wall section (24; 44); and a separate cover element (31; 51) for the free end (23; 43) of the belt cover (21; 41) and integrated in the circumferential wall section (24, 44) at the belt cover free end (23; 43).

2. A hand-held power tool according to claim 1, wherein the cover element (51) extends over a rim region (46) adjacent to the circumferential wall section (44).

3. A hand-held power tool according to claim 1, wherein the circumferential wall section (24; 44) extends over an angle of 180°, and the cover element (31; 51) extends over from 25% to 100% of an extent of the circumferential wall section (24, 44).

4. A hand-held power tool according to claim 1, wherein the cover element (31) has at least one rib (32) projecting radially beyond the circumferential wall section (24).

5. A hand-held power tool according to claim 4, wherein the at least one rib (32) extends in a circumferential direction of the circumferential wall section (24).

6. A hand-held power tool according to claim 4, wherein the cover element (31) has at least two, spaced from each other ribs (32).

7. A hand-held power tool according to claim 1, wherein the cover element (31, 51) is formed of metal.

8. A hand-held power tool according to claim 1, wherein the belt cover (21, 41) is formed of a plastic material by an injection-molding process, and the cover element (31; 51) is partially molded in the circumferential wall section (24; 44).
